(19) United States
(12) Patent Application Publication
(10) Pub. No.: US 2010/0174717 A1
(43) Pub. Date: Jul. 8, 2010

(54) Interative serialisation procedure for structured software objects

(76) Inventors: Olivier Fambon, Grenoble (FR); André Freyssinet, Saint Paul de Varces (FR); Serge Lacourte, Allevars les Bains (FR)

Correspondence Address: THE JANSSON FIRM, 3616 Far West Blvd, Ste 117-314, AUSTIN, TX, 78731, US

(21) Appl. No.: 10/505,935

(22) PCT Filed: Feb. 26, 2003
(86) PCT No.: PCT/IB03/00863

§ 371 Date: Jul. 25, 2005

(30) Foreign Application Priority Data
Feb. 28, 2002 (FR) 0202570

(51) Int. Cl. G06F 7/10; G06F 9/54; G06F 9/44; G06F 17/30

(52) U.S. Cl. 707/741; 707/811; 707/813; 707/E17.006

(57) ABSTRACT

This invention concerns an iterative procedure for conversion of structured software objects into a raw data stream and vice versa, providing for their direct transfer using simple communication resources such as those of an embedded computer station, and reset of said software objects or reutilisation of memory space allocated to them. This procedure can be used by an embedded platform (2) or a portable object including at least a processor capable of exchanging information with a terminal in the form of linear data sequences. The procedure includes a step for conversion of a data set, in one direction or the other, between a linear data sequence arrangement on the one hand, and a structured arrangement describing or representing an object-oriented software object on the other hand.

This invention concerns an iterative procedure for conversion of structured software objects into a raw data flow and vice versa, providing for their direct transfer using simple communication facilities such as those of an embedded computer station, and reset of said software objects or reutilisation of memory space allocated to them.

Within an application programmed in a high-level language, and in particular in structured or object-oriented languages such as Java®, a large proportion of the data used or processed is organised and stored in the form of software objects with a precise structure, more complex than a simple sequence of bytes. Such objects can contain a number of variables or data groups, for example in the form of simple types, such as characters (“char” type) or integers (“int” type), or basic object types or types defined by the programmer, character strings (“string” type), or arrays (“array” type) with one or more dimensions of the types defined above. Structured objects of this type can therefore be defined or represented by a tree structure grouping various objects themselves of varying types, the organisation of a structure of this kind sometimes being referred to as the object composition graph. An object type can be defined “by inheritance” from the definition of another type (generally referred to as a “super-type”), and all types can be represented in the form of a tree structure referred to as the inheritance graph.

According to the particular case, it can be useful to be able to transfer, create or delete software objects handled by a computer application, in hardware or software environments where these functions are not always possible or practical.

For example, numerous computer applications incorporate communication between a computer terminal and possibly a computer network on the one hand, and a portable object or embedded platform with data processing capabilities, such as a bank, telephone subscription or health care management smart card, or a computerised identification, marking or toll device on the other.

Such portable objects incorporate, in particular, a processor associated with storage devices, containing at least one application program and with facilities for communication with one or more terminals. These communication facilities are based for example on a transmission of electronic data using different types of technology, such as electrical contacts, radio antenna, luminous or other forms of transmission, it being possible to combine a number of different types of transmission in the same portable object. For dimensional and in some cases historical reasons, the communication facilities regularly employed operate with simple protocols such as the APDU protocol to standard ISO 7816 for smart cards. Some of these protocols only provide for the transfer of simple type objects (in the form of integers or simple characters) as control parameters transmitted to or received in response from the object, or only at the initiative of the terminal or both. In the case of the ISO 7816 standards, the APDU protocol only allows transfer of objects without types in raw data form, as bytes sent to the computerised portable object as control parameters, or obtained in response from the object, and only at the initiative of the terminal.

In the current state of their evolution, some of these portable data processing objects such as JavaCard® incorporate internal functions, enabling them to exploit programmed application elements directly in high-level or object-oriented languages such as Java®, and to be integrated in centralised or distributed applications communicating on an extended basis. To communicate with applications located inside an embedded platform of this type, the programmer of such an application must avoid using structured software objects, or provide for direct processing, and on a case-by-case basis, of the transfer of these objects to and from this embedded platform.

To take full advantage of the performance and the flexibility of a language of this type when programming an application which can be executed in the processor of a portable object of this type, it is consequently useful for the application to be able to communicate easily with other applications external to the object. It is therefore useful in this context, for the application to be able to exchange the objects it processes, without any loss of organisation or structure for these objects, with said external applications.

In programming languages such as Java®, the procedures used for serialisation/deserialisation of structured objects can rely on substantial hardware and software resources. These procedures are used in particular to save a structured object to a file, or transmit a structured object between two program processes executed in two different working memory fields.

These procedures nevertheless require software and hardware resources which are not available in certain embedded platforms, including Javacard® in particular. For example, the base classes used by a conventional Java platform occupy more than 1 MB of memory space (Java Developpement Kit: 9 MB), while a standard Javacard smart card only has 16 kB memory capacity.

Conventional serialisation procedures use the conventional resources of the Java environment, and their algorithms are designed with the aims of easy utilisation and computer-managed maintenance. They are consequently much more memory-greedy and much too complex for transposition to an embedded platform with such limited performance in terms of memory capacity and processor power and speed.

Furthermore, with Java for example, the serialisation procedures use a generic object type manager, implemented in the Java virtual machine (VM) executed on each hardware platform.

Due to the degree of concision necessary for adaptation to an embedded platform, the current versions of the Javacard environment do not incorporate type managers. A serialisation procedure such as that used in a standard Java configuration would not therefore have access to information representing the structure of the structured objects to be reconstituted from data received in APDU format.

Furthermore, in a conventional computer environment, memory facilities are such that the serialisation procedures implemented in object-oriented programming languages, such as Java, are not concerned with the size of the structured objects to be transmitted. The objects to be transmitted are serialised by the sender independently from their reception by the addressee, and the objects received can be deserialised by the addressee independently from the sender or the time of their transmission. Linear data streams are then transmitted and managed between sender and addressee by software mechanisms exterior to the programming environment. These streams can thus transit via high capacity buffers, and are managed by other software layers, for example by a protocol such as TCP/IP.

In the case of an embedded platform, the software mechanisms used to enable data exchange with the exterior do not provide stream management functions ensuring the integrity and continuity of the data transmitted. Nor do the modest memory resources of an embedded platform make it possible to store linear streams, and consequently large objects, during transmission and conversions.

One of the objectives of this invention is consequently to propose a procedure enabling the programmer of an application using an embedded platform, to have access to automated software tools enabling a software agent, or application element, stored or executed in a portable object of this type, to receive from or send to another agent, situated in another computer station, data organised in the form of structured software objects, in a case where the communication facilities between sender and receiver do not allow transfer of the structures composing said objects as such, but only to transfer data in a simpler form, and where the software and hardware resources of this embedded platform are not sufficient for enabling the use of a conventional serialisation procedure.

This objective is achieved by means of a data conversion procedure which can be used by a computer station, or embedded platform, comprising a portable object incorporating at least a processor, storage facilities, and communication facilities capable of exchanging information with a terminal in the form of one or more linear data sequences, characterised in that it incorporates a data set conversion step, in one direction or another, between a linear data sequence arrangement on the one hand, and a structured arrangement, describing or representing one or more software objects structured or hierarchised according to the criteria of an object-oriented programming language on the other.

According to a particularity of the invention, the procedure includes the following steps:
conversion, or serialisation, of a first data set to be transmitted, incorporating or representing one or more software objects, structured or hierarchised according to the criteria of an object-oriented programming language, from a structured arrangement describing or representing this object to a linear data sequence representing this first data set;
transmission of this linear data sequence using communication facilities, from the embedded platform to at least one host, namely a terminal or computer station connected to the terminal, or from this host to the embedded platform;
conversion after transmission, or deserialisation, of this linear data sequence to a data set arranged in one or more structured software objects reproducing or representing the first data set.

According to a particularity of the invention, the host terminal sends information to the embedded platform using a software agent, referred to as a transmission function, said information being received in the embedded platform by a response function which can initiate processing of these data by at least one addressee software agent stored in the embedded platform, and forming part of at least one application, the procedure incorporating the following steps:
reception by a communication agent representing the addressee agent, of a data set received by the response function for said addressee software agent, said data set being arranged in a linear data sequence;
conversion of this data set into at least one software object, structured or hierarchised according to the criteria of an object-oriented programming language;
transmission of this structured software object to the addressee agent, and initiation of a processing, according to said object, by said addressee agent.

According to a particularity of the invention, the procedure incorporates the following steps:
reception by the response function from the host transmission function, of at least one data item in the form of at least one transmission parameter, and transmission of this parameter to a communication agent stored or executed in the embedded platform;
conversion, or concatenation, by the communication agent of at least one transmission parameter, transmitted by the response agent, into a data set arranged in a linear data sequence, and storage of these data in an input stream in the embedded platform;
conversion, or deserialisation, by a serialisation agent, stored or executed in the embedded platform, of at least part of the data stored in this input stream into a data set comprising or representing at least one structured software object;
reception of this structured software object or its references by the addressee agent.

According to a particularity of the invention, the procedure incorporates the following steps:
transmission of a structured software object, or its representation, from a software agent forming part of an application executed or stored in an embedded platform, to a serialisation agent executed or stored in said embedded platform;
conversion, or serialisation, by said serialisation agent of said structured software object into a data set arranged in a linear data sequence, and storage of these data in an output stream in the embedded platform;
conversion by a communication agent, stored or executed in the embedded platform, of at least part of the data stored in this output stream into a set of response parameters suitable for transmission by the response function;
transmission of these response parameters from the embedded platform to the host terminal by the response function, on its own initiative or in response to the host terminal transmission function.

According to a particularity of the invention, the linear data sequence stored in the input stream or output stream represents one or more software objects, structured or hierarchised using one or more data items referred to as tags, having one or more given values each representing a given action to be executed on deserialisation of said linear data sequence.

According to a particularity of the invention, at least one tag is defined as representing one of the following actions:
addition of a new element to the structure of the structured object represented by the linear data sequence;
reference to an element or object, referred to as source object, as being source of the value of all or part of an element making up the structured object;
indication that the following data item or items represent the content of an element making up the structured object;
indication of the absence of content for an element making up the structured object.

According to a particularity of the invention, the serialisation agent serialises a structured object, referred to as source object, into a linear data set in accordance with a procedure, referred to as serialisation procedure, processing at least one of the objects, referred to as elements, making up the structure or tree structure of this structured source object, by the following steps:
detection by the serialisation agent of the type of an element, referred to as current object, making up the structure or tree structure of said structured object;
storage in the output stream of a data item representing a tag indicating the addition of a new element, followed by a data item representing the type of the current object;
storage in the output stream, following the elements already present in the stream, by a serialisation agent, of the type associated with the type of the current object:
   either by means of a data item representing the value of all or part of the structured object,
   or by means of a data item representing a tag indicating a reference to an object as source of the value of all or part of the structured object, said tag being followed by a data item identifying said source object.

According to a particularity of the invention, the serialisation procedure converts a structured object to the output stream, storing the type of each current object in a memory stack, referred to as type stack, the locations of which are read in reverse order to their order of storage, by successive iterations of the procedure.

According to a particularity of the invention, the serialisation agent deserialises a linear data set into at least one structured result object, by means of a procedure, referred to as deserialisation procedure, which processes each of the data items stored in the input stream, by the following steps:
read by the serialisation agent of at least one data item stored in the input stream following the data previously processed;
analysis of this data item and implementation of an action corresponding to this data item.

One of the objectives of the invention is also to propose a structured object transfer procedure of this type, making it possible to transfer software objects between a host and embedded platform, where the operating environment of said embedded platform does not incorporate type manager for said structured objects.

This objective is achieved by the data conversion procedure described above, characterised in that the deserialisation procedure includes the loading of an element, referred to as current object, namely assignment of a direct or indirect value to all or part of said current object, said element making up all or part of the structure of the structured result object, the termination of loading the current object initiating:
read of a data item representing an object type stored in the next location of a memory structure, referred to as type stack, and deletion of said data item from this location;
storage, as the type of a new current object, of the type represented by the data read from the type stack.

According to a particularity of the invention, the structured object created by the deserialisation procedure is considered as complete, and transmitted to the software agent or the application which is the addressee when the type stack is empty.

According to a particularity of the invention, the deserialisation operation corresponding to a data item representing a tag, referred to as “NEW” tag and indicating a new element, comprises the following steps:
read of at least one subsequent data item in the input stream;
storage of the object type represented by this subsequent data item, in a memory stack, referred to as type stack, following the types being possibly already stored in this stack.

According to a particularity of the invention, the type of stack used by the deserialisation procedure comprises a LIFO type stack, that is to say a stack where the locations are read in reverse order to the order in which they were stored.

According to a particularity of the invention, the deserialisation procedure comprises a step for creation of an element making up the structure of the structured result software object, by allocating a new memory space or reuse of a free allocation, said creation being performed by a type manager agent corresponding to the type of the element to be created.

According to a particularity of the invention, the creation step for an element making up the structure of the structured result software object occurs between the read step of a data item indicating the creation of this element, and the first loading step for said element.

According to a particularity of the invention, the action corresponding to a data item, referred to as simple data item, namely a data item not representing a tag, includes a step for storage of the value of this data item in the memory space allocated to the current object.

According to a particularity of the invention, during the deserialisation procedure, an object index is attributed to at least one element making up the structure of the structured result object, said object index identifying said element uniquely, and making it possible for the element to be designated or referenced by other objects or elements.

According to a particularity of the invention, the action corresponding to a data item representing a tag, referred to as “REF” tag indicating a reference, comprises the following steps:
read of at least one subsequent data item in the input stream;
storage in the memory space allocated to the current object, following the data items already stored, of a data item designating an object as source of the value of all or part of the current object, said source object or element being identified by said subsequent data item.

According to a particularity of the invention, loading of the current object is considered to be terminated when the data stored in the memory space allocated to said object corresponds to a given length, said length being read from card memory by a type manager agent, or a manager agent for the types stored in the embedded platform.

According to a particularity of the invention, transmission of a linear data sequence of a given length by the embedded platform to the host, is performed by an iterative procedure, referred to as data read procedure, comprising the following recursive steps:
transmission by the host of a communication command including at least one transmission parameter representing the length of the data already received;
reception by the embedded platform of the transmission parameter, and comparison with the linear data sequence to be transmitted;
response to the communication command by transmission of at least one return parameter representing the data item or items following immediately after the data already received by the host;
reception by the host of the communication command return parameter, and storage of the data which this represents following the data already received.

According to a particularity of the invention, reception by the embedded platform of a linear data sequence of a given length from the host, is executed following an iterative procedure, referred to as data write procedure, comprising the following recursive steps:
transmission by the host of a communication command with at least a first transmission parameter representing the data item or items following immediately after that part of the linear data sequence to be transmitted which has already been sent and, where appropriate, a second transmission parameter representing the position in the sequence to be transmitted, of the data represented by the first transmission parameter or the length of the data already transmitted;
reception by the embedded platform of the communication command transmission parameter or parameters;
storage in an input stream in the embedded platform of the data represented by the first transmission parameter, following the data already received.

According to a particularity of the invention, the data write procedure also comprises the following steps:
comparison by the embedded platform of the second transmission parameter, and comparison with the length of the data already received;
return by the embedded platform of at least one response parameter, representing either the length of the data already received, or a data item representing the result of this comparison, or both.

One of the objectives of the invention is also to propose a structured object transfer procedure of this type, making it possible to transfer software objects of a substantial size in relation to the possibilities of the communication facilities in terms of transfer or temporary storage, or software objects of unlimited size.

This objective is achieved by the data conversion procedure described above, characterised in that at least two serialisation, deserialisation, data read or data write procedures are executed in parallel or interleaved by repeating a step comprising successive execution of at least one step of each of these procedures.

According to a particularity of the invention, the input stream, output stream or both are stored in the form of circular memory structures, the two streams sharing possibly the same circular structure.

According to a particularity of the invention, the embedded platform has a programmable environment capable of storing and executing at least one application created by a programmer, the communication function being compatible with the APDU format defined in standard ISO 7816.

According to a particularity of the invention, the deserialisation and consequent processing operations for an object received are initiated on reception of at least one APDU format command containing at least one data item indicating reception of a structured object.

According to a particularity of the invention, the embedded platform has a programmable environment compatible with the JavaCard® standard.

According to a particularity of the invention, at least one of the applications executed on the host or embedded platform is programmed in Java® language.

According to a particularity of the invention, the procedure is used for communication between at least one software agent, referred to as card agent, stored or executed in the embedded platform, and at least one software agent, referred to as card engine proxy agent, stored or executed in at least one host belonging to a computer network communicating by asynchronous messages using an AAA-MOM type software infrastructure, said card engine proxy agent serving as an intermediary for the card agent for its communications with other agents in said network, said agents operating in accordance with the specifications of said software infrastructure and belonging to at least one distributed application.

Furthermore, in certain environments or operating systems, for example of the embedded type such as JavaCard®, there is no procedure, or only complex procedures which are costly in terms of resources, for deleting a software object of this type when it is no longer used, or to free the memory space which it occupies. Manual deletion is consequently required in this case, and must be provided for directly and on a case-by-case basis by the application programmer.

One of the objectives of this invention is consequently to propose a procedure which provides the programmer of an embedded platform-based application, with software tools allowing reutilisation of memory space occupied by all or part of certain structured software objects used by an application in a data processing station, whether portable or not.

It can also be useful to have software tools for simple duplication of a software object with a non-linear structure, for example in tree structure form.

One of the objectives of this invention is consequently to propose a procedure providing the programmer of an embedded platform-based application with software tools for duplication of a structured software object, referred to as source object, to another object, referred to as result object, containing the same values as the source object but constituting a different object in storage.

Likewise, for reasons of security, when memory space occupied by a software object of this type is freed, it can be important to erase information from this object from said space, to prevent said information being read by another object or another application using the same memory space subsequently. This information must therefore be erased manually, provision for this function being made directly and on a case-by-case basis by the application programmer.

One of the objectives of this invention is therefore to propose a procedure providing the programmer of an embedded platform-based application with software tools for erasing or uniformising information contained in the memory space used by a software object of this type, on deletion of said object or reutilisation of said space.

The invention consequently proposes a procedure as described above, characterised in that the data read, data write, deserialisation and serialisation procedures are applied via their implementation in at last one class stored in the host or embedded platform, said implementation involving at least one of the following commands:
an object write command, executing transmission of a structured object to at least one agent of the embedded platform, by utilisation of the serialisation procedure for this object, followed by the data write procedure and the deserialisation procedure;
an object read command, executing read of a structured object from at least one agent of the embedded platform, by utilisation of the serialisation procedure, followed by the data read procedure and the deserialisation procedure;
a deallocation command for a structured object stored in the embedded platform, by utilisation of the serialisation procedure, the latter also including a step for storage of freeing or de-allocation of the memory space allocated to each component of said object, following analysis of the structure of said component;
a housekeeping or erase command for a memory space freed by a structured object, by utilisation of the deserialisation procedure to create an object with non-material content from a given linear data sequence;
a duplication command for a structured source object by utilisation of the serialisation procedure, without deallocation of said source object, to create a linear data sequence representing this object, followed by utilisation of the deserialisation procedure from this linear data sequence, to create another structured object the content of which is identical to that of the source object.

According to a particularity of the invention, the programming language for the embedded platform comprises a first class (IOApplet) describing an ProcessAPDU abstract method initiating a process which can be user-defined in the application on reception of an APDU message; the program code executing the deserialisation operations in the embedded platform being stored in the embedded platform, for implementation of this ProcessAPDU abstract method, in a second class (ObjectIOApplet) inheriting from the first class (IOApplet), said program code using a ProcessObject method, the latter being described as an abstract method in this same implementation class (ObjectIOApplet).

According to a particularity of the invention, the programming language for the embedded platform includes a first class (IOApplet), describing a SendAPDU method transmitting an APDU format message to the host; the program code executing serialisation operations in the embedded platform being stored, for implementation of at least one SendObject method using the SendAPDU method, in a second card class (ObjectIOApplet) inheriting from the first class (IOApplet).

Another objective of the invention is to propose a computer system including a portable object and software tools of the types described above.

This objective is achieved with a computer system comprising a computer station, referred to as embedded platform, comprising a portable object incorporating at least a processor, storage facilities and communication facilities capable of exchanging information with a terminal in the form of one or more linear data sequences, characterised in that the platform incorporates a serialisation agent capable of executing a conversion step for a data set in one direction or the other, between a linear data sequence arrangement on the one hand, and a structured arrangement describing or representing one or more software objects, structured or hierarchised in accordance with the criteria of an object-oriented programming language, on the other.

According to a particularity of the invention, the embedded platform includes a communication agent capable of:
receiving, in place of the addressee agent, a data set received by the response function for an addressee software agent stored in the embedded platform, said data set being arranged in one or more linear data sequences;
converting this data set into at least one software object, structured or hierarchised in accordance with the criteria of an object-oriented programming language; and
transmitting this structured software object to the addressee agent, and initiating processing by the addressee agent according to this object.

According to a particularity of the invention, the linear data sequence representing a structured software object is stored in the embedded platform in an input or output stream, said embedded platform incorporating a software agent, referred to as serialisation agent, capable of creating the structured object or objects represented by the input flow in the embedded platform, namely deserialising said structured objects, or writing data representing the structured object or objects to be transmitted to the output stream, namely serialising said structured objects.

According to a particularity of the invention, the input or output stream is stored in the form of one or more circular memory structures.

According to a particularity of the invention, the serialisation agent uses a memory stack, referred to as type stack, to store the type of at least one object making up all or part of the structure of a structured object to be serialised or deserialised, said type stack having a number of memory locations which can only be accessed after the memory locations loaded most recently have been read and erased.

According to a particularity of the invention, the data contained in the input or output stream represents one or more structured objects, using a coding system comprising a set of tags, each of said tags representing a given action to be executed on deserialisation of the linear data sequence.

According to a particularity of the invention, at least one tag is defined as representing one of the following actions:
addition of a new element to the structured object structure represented by the linear data sequence;
referencing an element or object, referred to as source object, as the source of the value of all or part of an element making up the structured object;
indication that the following data item or items represent the content of an element making up the structured object;
indication of the absence of content for an element making up the structured object.

According to a particularity of the invention, the embedded platform comprises a portable object operating in accordance with standard ISO 7816 and using ADDU format commands.

According to a particularity of the invention, at least one agent or application stored in the embedded platform is programmed in Java® language, said embedded platform having a computer environment in accordance with the JavaCard® standard.

According to a particularity of the invention, the system incorporates, in the host, embedded platform or both, at least one software class implementing at least one of the following commands:
an object write command, executing transmission of a structured object to at least one agent of the card, by serialisation of this structured object into a data stream in the host, followed by transmission of this data stream to the embedded platform, and deserialisation of said data stream into a structured object in the embedded platform;
an object read command, executing read of a structured object from at least one agent of the card, by serialisation of this structured object into a data stream in the embedded platform, followed by reception of this data stream from the embedded platform and deserialisation of said data stream into a structured object in the host;
a deallocation command for a structured object stored in the embedded platform, by serialisation of said object in accordance with an option comprising freeing or de-allocation of the memory space allocated to each component of this object, following analysis of the structure of said component;
a housekeeping or erase command for a memory space freed by a structured object in the embedded platform, by deserialisation of a given linear data sequence to create an object with non-material content;
a command for duplication in the embedded platform of a structured object, referred to as source object, by serialisation to a linear data sequence representing the same object, without deallocation of said source object, followed by deserialisation from this linear data sequence into another structured object the content of which is identical to that of the source object.

According to a particularity of the invention, the embedded platform communicates at least with a host belonging to a computer network communicating by asynchronous messages in accordance with an AAA-MOM type software infrastructure, said host incorporating a software agent, referred to as card engine proxy agent, capable of managing communications between said embedded platform and other agents of said network, said agents operating in accordance with the specifications of this software infrastructure, and belonging to at least one distributed application.

The invention and its characteristics and advantages will be understood more clearly by reading the following description, with reference to the appended diagrams where:

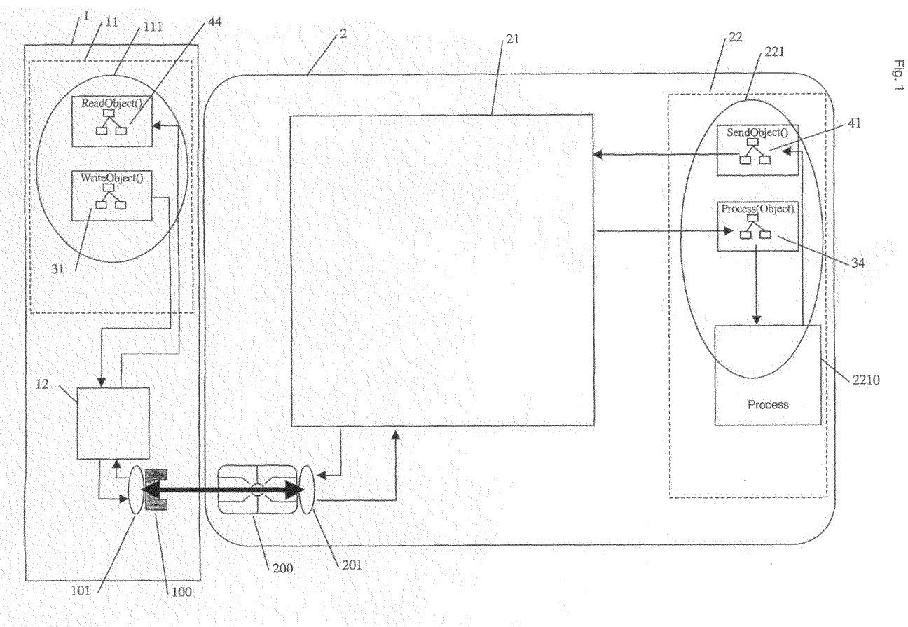

FIG. 1 is a partial diagram showing object transfer and conversion for read and write operations of a host or terminal to and from a software agent in an embedded platform, in a version of the invention where the card incorporates one application only;

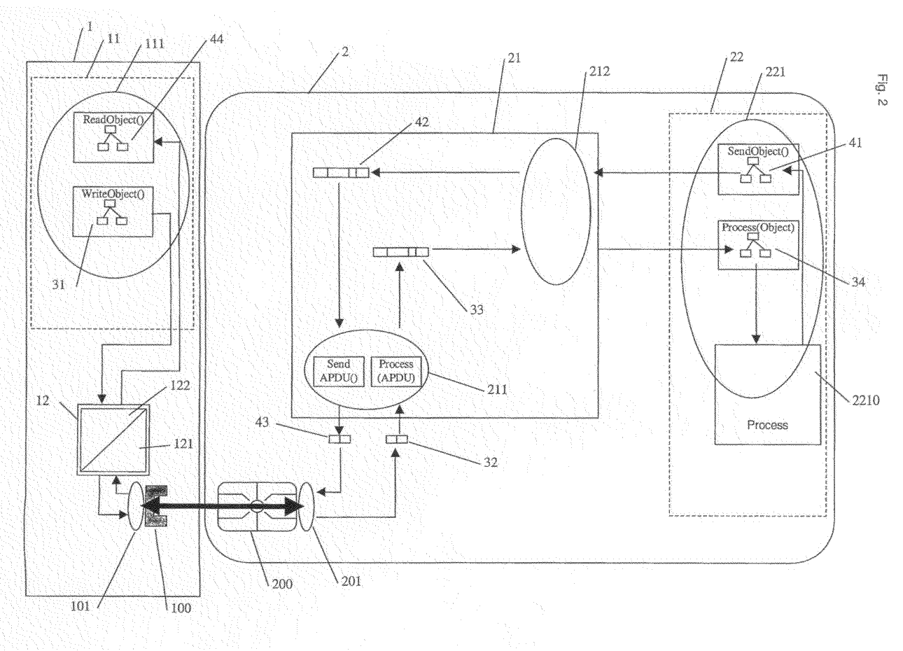

FIG. 2 is a more detailed diagram of object transfer and conversion for read and write operations of a host or terminal to and from a software agent in an embedded platform, in a version of the invention where the card has one application only;

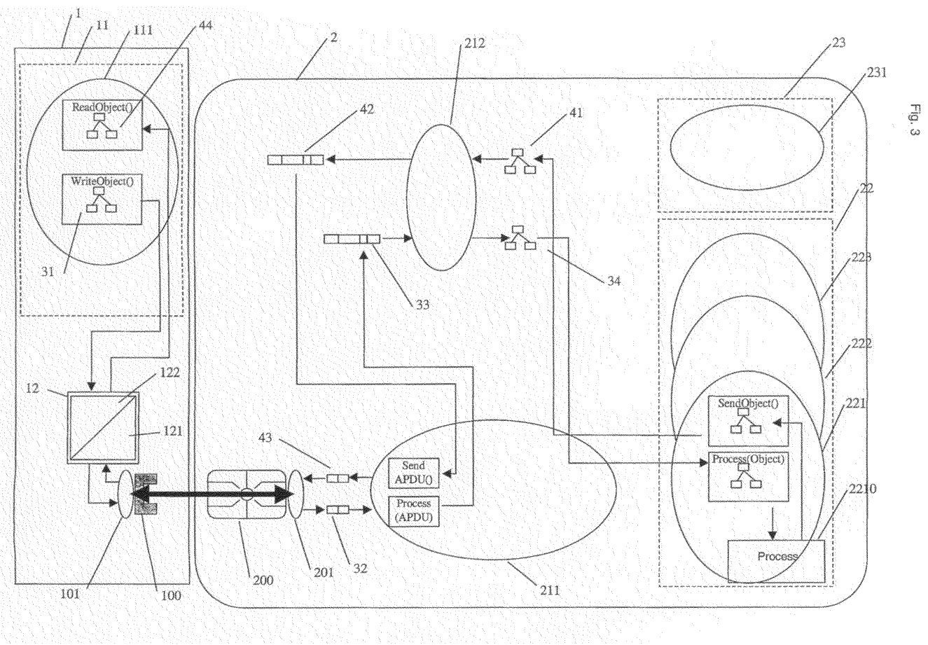

FIG. 3 is a partial diagram showing object transfer and conversion for read and write operations of a host or terminal to and from a software agent in an embedded platform, in a version of the invention where the card incorporates a number of applications;

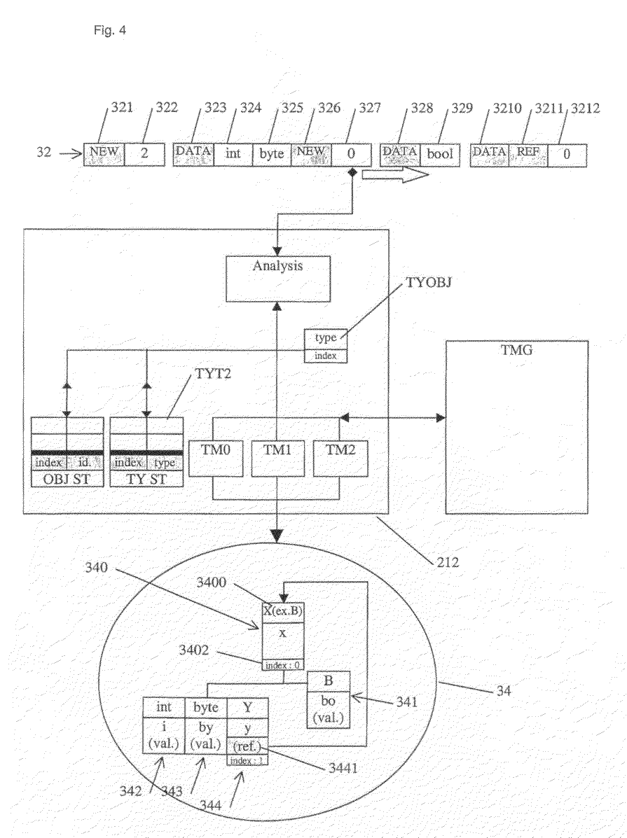

FIG. 4 is a partial diagram showing the objects and agents involved in deserialisation of a structured software object from a data stream;

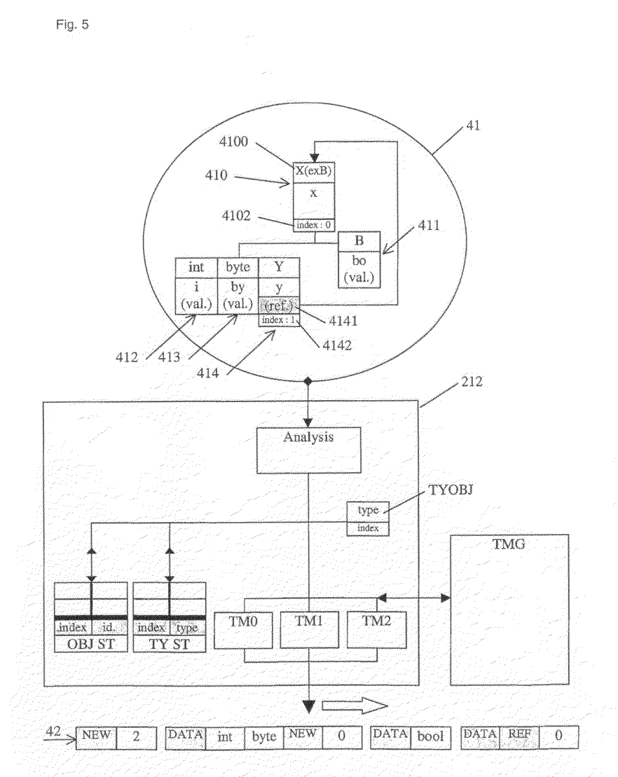

FIG. 5 is a partial diagram showing the objects and agents involved in serialisation of a structured software object to a data stream.

In certain literature (for example “Java embarqué”—Eyrolles—Paris 1999), the term “embedded computer” is used to designate a computer which is not visible per se, as it is integrated in an item of equipment possessing another function. The French term “ordinateur embarqué” is an approximate translation of the English “embedded computer”.

This characteristic, namely provision of a particular function within another device, largely explains the fact that such embedded computers frequently have only limited hardware or software resources, and frequently employ a rudimentary operating system or software environment. While enhancement is predictable, the resources of computers of this type can be typically of the order of 512 kb static storage down to a much lower figure, for a 8-bit or 16-bit processor. In the case of a smart card, available RAM capacity can be of the order of 4 kb, and currently up to 32 kb for the most powerful models.

In the general IT context, the term “platform” refers to a data processing device incorporating at least a processor and storage facilities. By extension of the above definition, and for purposes of description in this context, the term “embedded platform” is used to designate a portable object incorporating a platform of this type, said object being genuinely portable or of small size, or possessing very limited processing or storage capabilities.

The following description explains the procedure according to the invention for versions with given task and operation distribution between the various agents and applications concerned. The flexible organisation of a computer application naturally means that this distribution can be presented differently, in particular where distinctions between the various agents and their designations are abstract notions having no impact on their main operating characteristics. It is therefore obvious that the procedure according to the invention can also be implemented in other versions not described here, without deviating from the basic purport of the invention, in particular by combining the diverse variants presented for each task or agent in different ways. Likewise, abstract distribution of tasks between agents or applications stored in the same place at the same time, can also be combined in diverse variant versions not described here, without deviating from the basic purport of the invention.

The procedure according to the invention is illustrated, in the following description, principally in the case of an embedded platform comprising a smart card using a JavaCard® type system environment, communicating with a terminal comprising a data processing station executing an application programmed in Java® language.

It is however obvious that the procedure according to the invention can be applied to other environments, the data transmission functions of which do not provide for transmission of structured software objects in a mode which is transparent for the programmer. Smart cards to standard ISO 7816, using another programming environment, for example “Windows for Smart Cards®”, or which can be programmed using another programming language, for example Visual Basic®, can also be concerned. This also applies to smart cards complying with another standard involving similar limits in regard to their communication functions, or portable objects or terminals using a platform of this type.

The procedure can also be applied to any portable objects incorporating an embedded data processing station, whether portable or not, such as an electronic automobile component, identification marker, cellular telephone or portable acquisition terminal, for example.

Likewise, the procedure according to the invention will be illustrated principally as involving the utilisation of an embedded platform communicating with a data processing station, referred to as terminal or host. This procedure can naturally also be used in a case where the terminal is a station forming part of any type of computer network, without deviating from the basic purport of the invention. Thus, the various functions presented as being executed by this terminal can also be distributed between a number of different devices, and this distribution can vary in time. Naturally, the procedure described can also be described in a case where the embedded platform communicates directly or indirectly with one or more other embedded platforms, again without deviating from the basic purport of the invention. In general terms, the host or host terminal will consequently be defined as the application or station communicating with the embedded platform.

The procedure according to the invention can be applied, in particular, to communication between a smart card, for example to the JavaCard® standard, and a computer network, for example programmed in Java®, communicating by means of asynchronous messages in accordance with an AAA-MOM type software infrastructure. In this case, communications between the card and the remainder of the network are typically managed by a software agent, referred to as card agent proxy agent, serving as an, intermediary for each of the software agents, referred to as card agents, stored in the card. In the card environment, these card agents are managed or coordinated or both, by a software agent referred to as card engine agent.

The procedure according to the invention then enables this card engine agent to communicate with the card engine proxy agent, exchanging structured software objects in accordance with Java language or AAA infrastructure standards. The fact of being able to exchange structured objects with the exterior thus enables the card to achieve enhanced compatibility with the AAA infrastructure, and to be seen by the other AAA agents of the network as an AAA type agent itself.

The procedure according to the invention can also be applied to communication between a smart card, for example to JavaCard® standard, and a computer network, for example programmed in Java®, communicating by means of an object-oriented RPC (Remote Procedure Call) protocol, for example with a Java RMI (Remote Method Invocation) or CORBA® type software infrastructure.

Where an application requires transfer of software objects from a terminal to an embedded platform comprising a smart card, transfer often takes the form of a master/slave type communication. This means that the terminal takes the initiative for executing a transmission function to the embedded platform. To communicate, this function sends a communication command to the platform accompanied by transmission parameters. This command can then initiate one or more processing operations in the platform, and receive return or response parameters from the platform.

In the case of a smart card operating in accordance with standard ISO 7816, the parameters of this command are transmitted in an APDU (Application Protocol Data Unit) type format, comprising a data sequence organised as follows:

Transmission parameters sent with the command:

| | |
|---|---|
| Header | Body |

| | | | | | | |
|---|---|---|---|---|---|---|
| CLA | INS | P1 | P2 | Lc | Data T | Le |

CLA: one byte designating the addressee class or application.
INS: one byte designating an instruction to be executed.
P1, P2: two bytes providing information concerning the APDU command.
Lc: length of data transmitted.
Data: data transmitted.
Le: length of return data awaited.

Response parameters returned by the card:

| | |
|---|---|
| Body | End |

| | | |
|---|---|---|
| Data R | SW1 | SW2 |

Data: response data.
SW1, SW2: two bytes constituting check messages or codes sent by the card.

It will be seen that this APDU format does not provide for transmission or reception of data in any other form than a linear data sequence, namely a simple byte string. When an application is programmed in a language, or for an embedded platform for which the system does not have any other command than APDU communication commands, the programmer wishing to transfer more fully structured objects consequently has no simple software tools for the purpose. The programmer is then obliged to make provision in the application for conversion of structured objects of this type into a byte string, then using the APDU command to transmit the string and finally reconverting said objects in the opposite direction. This corresponds to manual serialisation, transmission and deserialisation of said objects, in other words programming of these operations in the smallest detail.

In the case of a programmer using Java® language for development of an application using JavaCard® standard embedded platforms, the tools available in JavaCard® provide for linear data transmission in APDU format using the following JavaCard® commands:
“process(APDU)”: the card receives data in APDU format, and initiates processing of the transmission parameters which they contain, by the addressee software agent or “applet” designated in these data;
“sendAPDU( )” or “APDU.sendbytes( )”: before or during the process previously initiated, the card returns other data in APDU format and containing return parameters to the host.

The “sendAPDU( )” command is implemented in the JavaCard environment in the “IOApplet” class, in the form of a method applicable to a non-typed object containing raw data.

The “Process(APDU)” command on the other hand is declared in the “IOApplet” class in the JavaCard environment, in the form of an abstract method. This means that the method exists in the Javacard environment, but also that the code implementing the method must be written by the programmer of an application for which it is desired to use this command. For example, the programmer creates an inheriting sub-class of the “IOApplet” class in the application, this sub-class then containing a method receiving the code of the process to be executed by this “Process(APDU)” method. The JavaCard environment merely calls the “Process(APDU)” method when a message is received, and then initiates the process which the programmer has included in the additional code.

To provide a programmer in this context with the tools for direct transmission of structured software objects, the procedure according to the invention provides similar commands, but which accept structured software objects directly, in accordance with the specific object-oriented characteristics of the Java® language. These commands can then be used in the JavaCard® environment, and can be of the “process(Object)” and “sendObject( )” type, for example.

To enable the programmer, also referred to here as the user, to employ these commands directly without having to become involved with APDU command syntax, the procedure according to the invention takes over serialisation, transmission and deserialisation operations for objects and data between the application or sender agent and the addressee agent.

In the case of a JavaCard environment, these operations can be performed by executing a program code contained in the “Process(APDU)” method belonging to a sub-class of the “IOApplet” class, named “ObjectIOApplet”, for example. This code is then initiated automatically by the environment when an APDU message is received, and itself contains the conversion operations and the call to another “Process(Object)” abstract method. With a version of the invention of this type, the programmer merely has to write the code for the operations to be executed by the card when a structured object is received. The programmer then writes this code in an inheriting sub-class of the “ObjectIOApplet” class, for implementation of the “Process(Object)” abstract method.

Only the conversion, serialisation and deserialisation operations executed at the card end are described in the following paragraphs. It is naturally clear that the procedure described can also be used for executing the same operations at the host end. The hardware and software resources of the host terminal being usually substantially greater than those available on the card, these operations can nevertheless also be programmed or organised differently at the host end without deviating from the basic purport of the invention.

In a version of the invention represented in FIG. 1, a host terminal (1) communicates with an embedded platform, for example a Javacard® standard smart card (2). Host (1) executes at least one application (11) comprising at least one software agent (111), and communicates with card (2) by means of an APDU format communication function (101), involving communication resources including a connection location (100), for example. This connection location incorporates a means of connection, for example by electrical contact, microwave link, IR link or magnetic track, or a combination of two or more of these types.

Card (2) executes an application (22) including at least one software agent (221), and communicates with the host (1) using a response function (201) forming part of the JavaCard® system environment. For this purpose, said response function (201) uses communication resources (200) of a type compatible with the communication resources (100) of host terminal (1).

When agent (111) of host application (11) wishes to send data to card agent (221), order it to execute a process (2210) or request information located in card storage, it executes an object write instruction initiating the procedure for sending structured software object (31) to the card, this instruction being designated “WriteObject( )”, for example. Said software object (31) is then serialised, namely converted to an APDU format data set by a host conversion agent (12). This host conversion agent then uses the communication function (101) to transmit these data to the card (2) via the host connection location (100) and the card communication resources (200).

When received in the card by the response function (201) which manages the communication resources (200), this response function transmits said data to a card conversion agent (21). Said card conversion agent (21) deserialises the data, converting them in the opposite direction to reobtain their original structure, in the form of a software object (34). Said structured software object (34) is then transmitted to the addressee agent (22), using an object processing instruction which will execute the process (2210) corresponding to the data received, this instruction being designated “Process(Object)”, for example.

When the agent (221) of application (22) in card (2) wishes to send data to the agent (111) of host (1), or information concerning a process executed, it executes an object transmission instruction which initiates the procedure for transmission of a structured software object (41) to the host, this instruction being designated “SendObject( ), for example. Said software object (41) is then serialised, namely converted to an APDU format data set, for example by the card conversion agent (21). This card conversion agent then uses the response function (201) to send these data to the card (2) via the card communication resources (200) and the host connection location (100).

When received by the host communication function (101) which manages the connection location (100), said communication function transmits the data to the host conversion agent (12). Said host conversion agent (12) deserialises the data, converting them in the reverse direction to reobtain their original structure in the form of a software object (44). Said structured software object (44) is then transmitted to the addressee agent (11) by an object read instruction which reads the data received, this instruction being designated “ReadObject( ), for example.

FIG. 2 represents a version of the invention where serialisation/deserialisation and transmission operations executed by the host and card conversion agents (12 and 21 respectively), are executed by two different agents (121, 122 and 211, 212 respectively).

The card conversion agent (21) thus comprises a communication agent (211) and a serialisation agent (212). The communication agent (211) manages the byte conversion operations, exchanging data in the form of transmission parameters (32) and response parameters (43) with the response function (201). For data reception, said communication agent (211) verifies that the data received are complete, and concatenates transmission parameters (32) in a linear data sequence stored in an input stream (33). For data transmission, said communication agent (211) reads a linear data sequence in an output flow (42), and separates these data for distribution as response parameters (43) compatible with the transmission capabilities of the response function (201).

The serialisation agent (212) manages the object level conversion operations, performing serialisation/deserialisation proper. For data transmission and consequently serialisation, the serialisation agent (212) analyses the structure and content of a structured software object (41) to be transmitted, and codes this object in the form of a linear data sequence stored in the output stream (42). For data reception and consequently deserialisation, the serialisation agent (212) reads a linear data sequence in the input stream (33). It then analyses the data in this stream, and reconstitutes the structured software object (34) which they represent.

FIG. 3 represents a version of the invention where the card can have a number of agents (221, 222, 223, 231) which can have addressee status for the procedure according to the invention, these agents being possibly distributed between one or more applications (22, 23). To be able to handle all data exchanges between the card (2) and the host (1), the procedure according to the invention includes an interface agent (210), via which all structured data exchanges between the card (2) and the host (1) transit.

In this version of the invention, the interface agent (210) receives all data transmitted to the card, in place of the application (22) or addressee agent (221), irrespective of said addressee. Said interface agent (210) then directs concatenation of transmission parameters (32) by the communication agent (211), and subsequent deserialisation of resultant data (33) by the serialisation agent (212), as described above. Once these data have been reconstituted as a structured software object (34), the same interface agent (210) transmits said structured object (34) to the software agent (221) which was the addressee for data (32) on their reception. In another version (not shown), the data (32) received by the interface agent (210) contain identification information for the addressee agent (221), or the interface agent (210) adds corresponding information to said data (32) before these are transmitted. The structured object (34) resulting from deserialisation is then addressed directly by the deserialisation agent (212) or a distribution agent (not shown).

In the same way, the interface agent (210) receives all data (41) transmitted to the host by a sender application (22) or a sender agent (221). Said interface agent (210) then directs serialisation of these data, by the serialisation agent (212), into an output stream (42), and concatenation of said output stream (42) by the communication agent (211), as described above. The data obtained are then sent by the response function (201) to the terminal (1) via the communication resources (200, 100) in the form of response parameters (43).

In another version of the invention (not shown), the interface agent (210) is inserted in the transmission and conversion chain (201, 211, 212, 221). For reception in the card (host write command), the interface agent (210) directs the data or objects received to their addressee (221, 222, 223, 231) in the card, according to information included in the data received. For transmission from the card (host read command), the interface agent (210) can also be included to receive data or objects to be transmitted, assigning information to said data or objects representing their sender (221, 222, 223, 231).

It can be considered that information exchanges between the host (1), whether this is the terminal itself or any software agent capable of managing this terminal, and an agent or application present on the card, are consequently executed at two different levels, namely byte level and object level.

At object level, the data organised in structured software objects to be transmitted are converted into a linear data stream, and vice versa. This serialisation step manages the structure of the object, and is executed by the serialisation agent in each platform.

At byte or byte string level, the data arranged in simple linear streams are transmitted by fragment using the transmission function, for example in APDU format, this being the only means of exchanging information between the card and the outside world. These exchanges are managed by the host and card communication agents, which communicate with each other by sending parameters using this transmission function.

To provide the user with transparent commands, the various processes are implemented in one or more classes, and generally with at least one operating in the card and one in the terminal or host. In Java® language, the procedure according to the invention can so provide an “ObjectIOApplet” class for the card and an “ObjectIOProxy” class for the host, using the following syntax:

| class ObjectIOProxy { | |
|---|---|
| void | writeObject (Object o); |
| Object | readObject ( ); |
| } | |

with the “ObjectIOProxy” class defining a class in the host, providing the user application with “writeObject (Object)” and “readObject 0” commands:

```
class ObjectIOApplet {
    void  process (Object o);
    void  sendObject (Object o);
}
```

and with the “ObjectIOApplet” class defining a class in the card, providing the user application with “process(Object)” and “sendObject( )” commands.

As the card is essentially passive, all these conversion and transmission operations are executed at the initiative of the host, using an instruction in the code which triggers transmission of an APDU command. It is this command that initiates the conversion operation requested from the agent concerned.

When executed in the card application code, the “process(Object)” and “sendObject( ) commands do not therefore trigger the corresponding conversion operations directly. The “sendObject( )” command stores the object to be transmitted in an output queue, for example “qout”, where the objects to be serialised for transmission are introduced by an introduction command of the “qout.push(object)” type. When a serialisation operation is initiated, these objects to be transmitted are extracted from the output queue in the same order as they were introduced.

Likewise, the command extracts an object serialised by a previous operation initiated by the host, from an input queue, for example “qin”. Said extraction is obtained by an extraction command of the “qin.pop( )” type.

The read, write, serialisation and deserialisation operations are then managed from the host by the “ObjectIOProxy” class, using user-transparent commands. These commands can be implemented in the code of this class, in the following form for example:
“card.Serialize out”: initiates serialisation in the card of the object to be transmitted, as described below. These objects can have been stored in an output queue on execution of a “sendObject( )” instruction by the card application;
“card.Read”: initiates output stream data read in the card, and transmission of these data to the host, as described below;
“card.Write”: initiates transmission of data to the card, and data write to the input stream, as described below;
“card.Serialize In”: initiates deserialisation of the objects present in the input stream in the card, as described below.

In the version of the invention described here, the card output and input streams are stored in the same circular memory structure. Other versions of the invention are naturally possible, using a different memory structure for each stream or using other types of memory structure.

A circular memory structure corresponds in this case to a set of successive memory locations, the first location being considered by the system as following immediately after the last location. This means that a linear data sequence can be stored in a structure of this type starting at any location, without loss of continuity, provided the length of said sequence is not greater than the total number of locations.

The fact that the input and output streams share the same circular structure involves storing the data which they contain in different areas of this same circular structure. The data contained in these streams being erased as they are read, immediately or during an operation, the length and position of the two streams vary inside this circular structure. When one of the two streams has no more space to store new data as it is blocked by non-erased data of the other stream, it is merely necessary to process the other stream to free the space which it occupies.

A circular structure of this type makes it possible to use limited storage resources for processing streams the length of which is not determined in advance. It is merely necessary for the different operations on the two streams to be interspersed sufficiently evenly for this purpose.

At byte level, data exchanges from a platform output stream to the input stream of the other platform, and vice versa, are executed as described below.

If the host wishes to obtain data located in the card output stream, it sends a read command, for example “card.Read” for Java® syntax. This command initiates a read session, typically divided into a number of transactions, each transaction representing one iteration of the process.

To initiate the read session, the host issues an APDU format command, accompanied by transmission parameters (P1 and P2, corresponding to a short integer) representing the length of the data which it wishes to receive, via its communication agent and transmission function. On receipt of this command from the communication agent, the card reads a first data block in the card output stream, and transmits this block to the card response function. This first data block is then returned to the host as response data (DataR) in the response to the APDU command.

Each successive iteration of the read process then involves transmission of an APDU command by the host, accompanied by transmission parameters (P1 and P2, namely a short integer) representing the length of the data already received. Once received by the card communication agent, this length serves as an acknowledgement for previous transmissions. Thus, the communication agent returns the output stream data immediately following the length indicated by the host, as response data (DataR). It should be noted that data are read from the output stream but are not erased, and can consequently be retransmitted in case of need. This means that no data can be forgotten in this transmission.

The read session terminates when the length requested by the host has been received correctly, and the host stops the iterations. The session can also be terminated, or interrupted, if the card communication agent sends a data item (for example, a DataR field with zero length) or a code (SW1 or SW2) signifying that all available data in the output stream has already been sent. If the card output stream is empty, the host must then initiate a new object serialisation operation from the card “qout” queue to the card output stream, in the card, for the output stream to receive fresh data.

When the host wishes to transmit data from its output stream to the card, it sends a write command, for example “card.Write” for Java® syntax. This command initiates a write session, typically divided into a number of transactions, with each transaction representing one process iteration.

To initiate the write session, the host sends an APDU format command, accompanied by transmission parameters (P1 and P2, namely a short integer) representing the length of the data it wishes to transmit, via its communication agent and transmission function. The data field (DataT) of this first APDU command then contains the first data block or group to be transmitted, this data block being read in the host output stream. On receipt of this command, the card response function transmits said first data block to the card communication agent. The card communication agent then writes this first data block to the card input stream.

Each successive iteration of the write process involves transmission of an APDU command by the host, accompanied by transmission parameters (P1 and P2, namely a short integer) representing the length of the data already transmitted. The data field (DataT) of this first APDU command then contains the next data block or group read from the host output stream. On receipt of this command, the card response function transmits these parameters and this data block to the card communication agent. The card communication agent then compares the data length announced in the transmission parameters (P1 and P2) with the length of the data already received since the beginning of the write session. This means that no data can be forgotten in this transmission.

If this comparison identifies no errors, the card communication agent writes this data block to the card input stream. If an error is detected, the communication agent returns a code or index to the host, indicating an error and/or representing the nature of this error. This code or index can be returned via the response parameters (SW1 and SW2) of the response function, the returned data field (DataR), the length of this field or a combination of these elements.

The write session terminates when the length announced by the host has been transmitted, and the host stops the iterations. The session can also be terminated, or interrupted, if the card communication agent sends a code or index indicating that the card input stream cannot receive any fresh data. The host must then initiate one or more operations in the card for freeing space in the memory structure containing this input stream.

This can involve initiating in the card a new data deserialisation operation from the input stream to the “qin” input queue of objects accessible to the card application. This can also involve initiating a new read session to receive data contained in the card output stream, and thus free space in the circular structure containing the two streams.

At object level, serialisation and deserialisation operations are executed between the data streams and agents or applications of the card, and vice versa, as follows.

Objects are deserialised in the card from input flow (33) to the “qin” input queue, where they are directly accessible to the “Process(Object)” instruction, provided by the “ObjectIOApplet” class and used by the addressee agent or application.

For implementation of the procedure according to the invention, the host uses an instruction when it wishes to initiate a deserialisation operation in the card, for example “card.Serialize In” for Java® syntax.

FIG. 4 illustrates deserialisation of a structured software object (34) by decoding the data of input stream (32) corresponding to said object (34), and storage and structure component creation operations for said structured object (34), or result object.

Reading one after the other the data stored in a linear sequence in the input stream (33), the serialisation agent (212) interprets these data according to a given code, and creates a structured software object (34) based on this interpretation. Certain data in the data sequence stored in this input stream can have a given value, and this value is interpreted as indicating the presence of a code tag. This decoding can be performed by calling an allocation method particular to each type of structured object to be decoded, for example using the following syntax:

Typeobject::decode (Object, InputStream)

to decode an object “Object” of type “Typeobject”, from the input stream “Input Stream”.

This code comprises a set of tags each having a given significance, and each corresponding to at least one specific value of a data item in the input stream. Thus, each data item in the input stream having a value corresponding to one of these tags is interpreted by the serialisation agent during the deserialisation process.

For applications using the procedure according to the invention, the serialisation agent (212) can be designed to recognise a number of tag sets, or each tag can be represented by a number of different data values, without deviating from the basic purport of the invention. Diversity of this type can be used, in particular, for accounting for one card (2) or card type, with a number of different terminals or host environments.

For the version of the invention described here, the code comprises tags of the “NULL”, “NEW”, “REF” and “DATA” type.
A NULL tag represents an absence of data, while occupying a location in the structure in course of construction by the serialisation agent.
A NEW tag indicates the beginning of the description of a new object to the serialisation agent, this object being structured software object (34) resulting from the conversion, or an object, referred to as element, comprising part of a structured object (34) of this type.
A REF tag indicates the designation of an object, the same or another object, as value source for all or part of the object or element in course of description. This is used to assign a value by reference.
A DATA tag indicates that the following data represent the value or content of the object or element in course of description. This content can comprise raw data representing one or more values to be assigned to the object directly, or include other tags again indicating objects or references defining this content.

According to its type, a tag can be followed by one or more data items, interpretation of which is determined by the meaning of the tag concerned.
On reading a NEW tag, the serialisation agent knows that it must interpret the following data item as representing the type of the new object described.
Likewise, on reading a REF tag, the serialisation agent knows that it must interpret the following data item as representing an identifier for the object designated as source of this value by reference.

In the version of the invention described here, the tags are coded on one byte in the same way as type and reference identifiers but it is obvious that the procedure according to the invention also provides for the utilisation of other codes, which are different or more complex or explicit according to the needs and possibilities of the computer environment concerned.

As it reads the data of input stream (32), the serialisation agent (212) analyses the value of each data item, and creates and loads objects or elements (340, 341, 342, 343, 344) making up the result object (34). This read of input stream (32) is repeated until reconstruction of the object (34) represented by this input stream has been completed. This creation can be obtained by calling an allocation method particular to each object type, for example using the following syntax:

Typeobject::malloc( )

for creation or allocation of a “Typeobject” type object on deserialisation.

As objects of this type can have different structures, these creation and loading operations are managed, whether directly or not, by a management agent (TM0, TM1, TM2) of a type specific to the type of object to be created, for example a “type marshaller” agent in Java® language. This type management agent is specific to one or more object types, and can be managed by a generic type manager agent (TMG), for example a “type manager” agent in Java® language. In particular, this type manager agent stores the identifiers for the various object types created during the deserialisation process. This generic type manager agent (TMG) also includes the codes and procedures, or methods, specific to these different object types and used for serialisation/deserialisation of the same objects. The type manager agent is also used to manage the list of objects and their allocations, making it possible to execute new allocations and reuse a free allocation to create a new object on decoding.

Typically, the type manager agent (TMG) includes information on all the different types of object which can be managed in the card. This information can be generated by a host, for example during a card programming phase. The information is then transmitted with classes (“applets”) used by the applications, in the form of a program code (“glue code”) which is added to the code of the generic type manager agent (TMG).

Using a type manager agent, and type marshaller agents as described below, the procedure according to the invention makes it possible to manage the serialisation and deserialisation of structured objects of basic or constructed type, in an embedded platform the programming environment of which, such as JavaCard for example, does not include such a type manager.

Creation of an object or element during decoding corresponds to allocation of this object, namely reservation of given memory space, and allocation of this space to the object. Some embedded environments, including Javacard® in particular, do not include software tools which can be used to free memory space previously occupied by a deleted object, such as a conventional Java® language “garbage collector” agent. On creation of an object by the serialisation agent (212), the procedure according to the invention can provide for the possibility of executing this creation with allocation of memory space to this object which had previously been occupied by another object which had become superfluous, for example of the same type as the object to be created. It is consequently possible to reuse card memory space from time to time, this frequently being a valuable asset due to card memory space limitations.

In the example illustrated in FIG. 4, the input stream (32) corresponds to a structured result object (34), the structure, or graph of which can be described in Java® language in the following form:

| | |
|---|---|
| Type1: {bool} | class B {boolean bo ;} |
| Type2: Type1+{int, byte, Type0} | class X extends B { |
| | int i ; |
| | byte by ; |
| | Y y ; |
| | } |
| Type0: {Type1 } | class Y { B b ;} |

On reading the input stream (33), the serialisation agent reads a NEW tag (321) first. It therefore reads the following data item (322), and then stores the creation request for a type 2 object. In accordance with this NEW identifier 2 tag (321), the serialisation agent creates new object “x” (340), of class X in the example, using the type manager agent (TM2) corresponding to the same type (Type2). At the commencement of description of a result object, this new object will be the “root” object of the tree structure of the graph for this result object.

On this creation, the serialisation agent assigns an index (3402) to the newly created object (340), this index taking a value of 0 in the example. Said index (3402) can thus serve as a reference for other elements or parts of elements on construction of this result object (34), making it possible to determine whether the content of this element has been loaded or not.

The serialisation agent then stores the type and index of this object in a memory structure, referred to as type stack (TYST). This type stack is a memory stack type structure, which means that data items can be stored (pushed) one on top of the other, and a given data item can only be read and extracted (popped) when the data stored subsequently have already been extracted. Data are extracted from the stack in the reverse order to that in which they were stored (LIFO for Last In First Out).

The serialisation agent also stores the type of said new object (340) and its index, as corresponding to the object, referred to as current object (OBJ), which will be loaded with the next data in the input stream.

The next tag is a DATA tag followed by two raw data items (324, 325), which are not tags or identifiers. These two data items are therefore stored in the current object (OBJ), namely x (340) as the value of the following elements (342, 343). These two following elements are integer type (int) designated “i”, and byte type (byte) designated “by” respectively, these elements taking the values contained in these two data items (324, 325) of the input stream respectively.

The next tag is a NEW tag, followed by a data item indicating type 0. This sequence indicates that the next element of object “x” is a type 0 object. The serialisation agent will therefore assign an index (3442), 1 in the example, to said object (344), and add (push) the index and type, namely 0, for said new object (344) to the type stack (TYST). The serialisation agent will also have a type 0 object, “y” (344) of type Y in the example, created by type manager agent (TM0) corresponding to type 0.

Via the type manager agent (TM2) corresponding to the current object (OBJ), the serialisation agent knows that said current object (OBJ), namely “x”, is not fully loaded. The next tag, a DATA tag followed by a raw data item (329), will consequently be assigned as value for the next element (341) of the current object, namely as the value of Boolean type element “bo”, this being the last element of object “x”.

Via the type manager agent (TM2) corresponding to the current object (OBJ), the serialisation agent knows that said current object (OBJ), namely “x” (340), is now fully loaded. The index (3402) of said loaded object (340) is then stored in the object stack (OBJST), with the identifier of this object (340) in the card. The serialisation agent then terminates loading of the current object, and extracts (pops) the type and index stored at the top of the type stack (TYST). The top of the stack must naturally be understood as the stack location accessible first. The type and index extracted from the type stack, 0 and 1 respectively in the example, are then stored as corresponding to a new current object (OBJ).

The next tag is a DATA tag, which therefore indicates the loading of the current object, namely “y”. This tag is followed by a REF tag (3211) and a data item (3312), 0 in the example. The serialisation agent therefore assigns a value by reference to object “y” (344), representing a simple link with the value of the object for which the index (3402) is designated by this reference (3212). Object “y” will therefore have a value defined as referencing object “x”, which has index 0 in the deserialisation process. This link can then be defined in the result object (34) by storing the identifier for this object “x” in the card, this identifier being read from the object stack (OBJST) by means of this index.

Via type manager agent (TM0) corresponding to the current object (OBJ), the serialisation agent knows that said current object (OBJ), namely “y”, is now fully loaded. The index (3442) of said loaded object (344) is therefore stored in the object stack (OBJST), with the identifier for said object (344) in the card. The serialisation agent then terminates this loading and interrogates the type stack (TYST).

As the type stack (TYST) is empty after extraction of the type of object “y”, namely there are no more “constructed types” to be reconstituted, the serialisation agent concludes that the result object (34) has been created in full.

In a variant version of the invention, the creation or allocation of a new object can be performed at any stage of the deserialisation process, from read of the NEW tag indicating said new object, up to commencement of loading of this object.

In another variant, the index used on deserialisation of an object is identical to the identifier of the object in the card.

Objects are serialised in the card from output stream (42) to output queue “gout”, which can be accessed directly by the instruction “SendObject( )” supplied by the “ObjectIOApplet” class and used by the addressee agent or application.

For implementation of the procedure according to the invention, the host uses an instruction, for example “card.Serialize Out” for Java® syntax, to initiate a serialisation operation in the card.

FIG. 5 illustrates the serialisation of a structured software object (41), referred to as source object, by analysis of the components of the structure of said structured object (41), followed by coding in the form of data stored in the output stream (42) corresponding to said source object (41).

This serialisation function is implemented in a method, namely an action or procedure available for an object of a given type, using the following Java® syntax:

Typeobject:: (Object, OutputStream)

being a method used to code an object “Object” of type “Typeobject” to the output stream “OutputStream”.
Typeobject::getSuper( )
being a method used to obtain information concerning the type and constructed types of an object, on coding a “Typeobject” type object.

The basic types are generally those types scheduled and managed by the environment or programming language, in contrast to constructed types, defined as a combination of a number of objects. Current basic types are “integer”, “Boolean” and “byte” for example for an embedded environment, and long integer, real, long real and character types (“long”, “real”, “double” and “char”) for more comprehensive environments.

For this serialisation operation, the serialisation agent (212) executes a recursive scan on the complete structure, or graph, of the source object (42) to be serialised, analysing the object elements (410, 412, 413, 414, 411), starting with the “root” object or element, “x” in the example. The graph of the source object (42) presented in the example is the same as described above for FIG. 4. The serialisation agent calls an agent (TM0, TM1, TM2) corresponding to the same constructed type, for each graph element having a constructed type.

Description of the source object (41) in the output stream (42) commences by writing a NEW tag, followed by the root element type identifier, type 2 object “x” in the example. This root object is then designated as current object (OBJ). This object also receives an index, 0 in the example, and its type and index are then loaded (push operation) in the type stack (TMST).

The description is continued by writing a DATA tag, followed by data indicating the values or references corresponding to the content of the root object. As root object “x” contains an object “y” (414) which is a constructed type, the description of the root objective includes a NEW tag, followed by the type of said object “y”, “NEW 0” in the example, in place of the value of said object “y”. An index is assigned to the NEW tag, 1 in the example, when this tag is written. The index and type of this new object are then loaded (push operation) in the type stack (TYST).

When description of the content of object (OBJ), namely object “x” (410), has been completed, the index of this object is stored in the object stack (OBJST) with the identifier of this object. The serialisation agent then interprets the type stack, extracting (“pop” operation) the type and index of object “y”. It stores said object “y” as new current object (OBJ), and then commences description of the content of said object “y”. This object comprising a simple reference to the root object “x”, the data written to the output stream comprise a REF tag, followed by a data item serving as index for the object to be designated as reference, namely the object “x” with index 0 in the example.

Once description of the content of the current object, namely object “y” (414) has been completed, its index is stored in the object stack (OBJST) with the identifier of this object. The serialisation agent then interrogates the type stack, extracting (pop operation) the type of object “x” which was stored under object “y” in this type stack. As the index of object “x” is already stored in the object stack (OBJST), the serialisation agent knows that object “x” has already been serialised or described. It consequently interrogates the type stack again, observes that it is empty, and consequently concludes that all elements making up the source object (34) have been fully described in the output stream (42).

Due to the recursivity of these algorithms, it is possible to perform these serialisation and deserialisation operations using a program code which takes up sufficiently little memory space for it to be possible to store the code in an embedded platform, for example a smart card or JavaCard standard portable computerised object. The concision of these algorithms also makes it possible to execute these operations with a low-power processor, such as those used in such embedded platforms.

In order to balance the volume of data stored in temporary form, the various read, write, serialisation and deserialisation operations required by the host application (11) can be interleaved in one or more program loops. A loop of this type executes a command for each of these operations on each iteration, for example using the following Java® syntax:

```
Do
    Do card.Serialize out While (ok out)
    Do card.Read While (data read)
    While (data in) card.Write
    While (ok in) card.Serialize in
Loop
```

In this example, the first and last lines (“Do” and “Loop”) determine the repetition of a loop comprising the four intervening lines of code. A loop of this type can naturally be combined with other operations, and include various conditions for interrupting the iteration process.

The first line in the loop indicates initiation of a serialisation session to the card output stream, for objects previously stored in the “qout” output queue by a “SendObject( )” command, in the card. This session is then repeated as long as an “ok out” condition is met, for example as long as there are objects to be transmitted in the “qout” queue, and the output stream is not full.

The second line indicates initiation of a read session for data contained in the card output stream by the host. This session is then repeated as long as a “data read” condition is met, for example as long as data are received from the card.

The third line indicates execution and repetition of a write session to the data input stream from the host. This session is only executed and repeated if, and as long as a “data in” condition is met, for example as long as there are data to be sent to the card and the card entry stream is not full.

The fourth line indicates execution and repetition of a deserialisation session for data contained in the card entry stream to the structured object “qin” entry queue, where these data are extracted by a “process(Object)” command. This session is only executed and repeated if, and as long as an “ok in” condition is met, for example as long as there are data to be deserialised in the card entry stream.

In the case of a passive card, to JavaCard® standard for example, the end of an object serialisation operation typically initiates processing of the object, for example by automatic call to the “process(Object)” method.

It should be noted that only operations executed at the card end are illustrated in this example. Symmetrical operations executed at the host end can be performed either in a similar or totally different way, according to the hardware and software resources available, without deviating from the basic purport of the invention.

Due to the fact that these various complementary operations are interleaved in a software loop which can be repeated recursively, the various phases involved in the transfer of a structured object can be executed in parallel, within the framework of a single execution or single transfer command. Using data streams stored in circular form, and reusing the same memory space indefinitely, as described above, the same command can initiate complete transfer of a structured object with no restriction on size despite the limited capacities of the embedded platform.

Where all the conversion operations described above are implemented, namely programmed, in one or more procedures loaded in the host and the embedded platform, said procedures can then be accessed by the user with a few simple commands.

In the version of the invention described here, as applied to the Java® language and JavaCard® environment, an application programmer only needs to use these few simple commands to create the application. These commands perform all intermediate operations transparently for the user. In other words, the user has no need to become involved with internal operation of the mechanism of said commands.

For example, the “ObjectIOProxy” class loaded in the processing station or host terminal supplies the “WriteObject( )” and “ReadObject( )” commands.

Likewise, the “ObjectIOApplet” class loaded in the embedded platform supplies the “Process(Object)” and “SendObject( )” commands. Typically, the “ObjectIOApplet” class implements these commands using a known extension technique, namely by inheritance from the “IOApplet” class which contains the “process(APDU)” method. This involves adding the program code combined with the initial method to this method, and modifying or replacing operation of the code as defined in the initial method.

Instruction “WriteObject( )” is employed by the user in its host application, for transmitting a structured object to the card application and initiating processing in the card.

The “Process(Object)” method is called automatically by the card following reception and deserialisation of a structured object. The content of this method is then programmed by the user in that part of the application loaded in the embedded platform, to execute the desired operations from this object. This method is then used in a similar way to the standard “process(APDU)” command in JavaCard® for APDU format data only.

The “SendObject( )” instruction is employed by the user in that part of the application loaded in the embedded platform, for example inside the “Process(Object)” method code, to prepare transmission of one or more structured objects from the embedded platform to the host. This instruction is then used in a similar way to the standard “sendAPDU( )” command in JavaCard® for APDU format data only.

The “ReadObject( ) instruction is employed by the user in its host application, for reception of the structured object or objects which the card application has prepared for this purpose, from the embedded platform.

It will be understood that is easier for a programmer creating an application involving an embedded platform of this type, to transmit structured software objects between said embedded platform and a host or terminal, even if the communication resources of said embedded platform are not capable of transmitting data in byte or integer form.

It can be useful for the programmer of an embedded application to have a few simple commands for deallocation of a structured software object, or reset or erase of corresponding memory space, as also duplication of a structured software object. This is particularly true in a case where the programming environment of the embedded platform does not possess a garbage collector software tool managing reutilisation of memory space already allocated, for example in the JavaCard® environment.

In a version of the procedure according to the invention, the analysis step for each component of a structured software object during serialisation of the object, can be performed using various options. A number of these options can be included in implementation of the same serialisation command, each execution of this command being accompanied by a parameter indicating which option must be used. These various options can also be used separately in different implementations of the serialisation command.

In one of these options, on analysis of each component of a structured software object during serialisation of the object, the serialisation agent (212) deallocates the memory space containing this component, or marks said component as being reusable for a new allocation. Thus, serialisation using this option, referred to as destructive serialisation, executes conversion of a structured object after which the memory space occupied by the object is freed.

In another version, the procedure according to the invention can include an option or command which executes this type of destructive serialisation of a structured object stored in the card, outside any transmission operation, for example in implementation of the “ObjectIOApplet” class. It will be clearly understood that the procedure according to the invention enables the user to reuse memory space occupied by all or part of some of the software objects of the application, without difficulty.

In another version (not shown), the procedure according to the invention includes an option or command executing deserialisation of a structured object by reusing the memory space in the card previously occupied by a structured object which has since been destroyed, as described above. This deserialisation is executed, outside any transmission operation, from a data stream containing data which is all identical or non-material. After allocating and writing an object of this type, the memory space reused does not contain any data belonging to the object previously occupying the space concerned. When this operation is implemented, for example in the “ObjectIOApplet” class, the procedure according to the invention enables the user to program total erase of memory space corresponding to a given allocation without difficulty.

In another version (not shown), the procedure according to the invention includes an option or command executing serialisation of a structured source object to a linear data sequence, outside any transmission operation. This same linear data sequence is then deserialised into a result object identical to the source object, but using a different memory space. When this operation is implemented, for example in the “ObjectIOApplet” class, the procedure according to the invention enables the user to program identical duplication of a structured software object without difficulty.

It will be obvious to the specialist in this domain that this invention provides for versions in many other specific forms; without deviating from the field of application for the invention as claimed. Consequently, the version described must be regarded as being provided for illustration purposes only, and can be modified in the domain defined by the scope of the attached claims. The invention must not therefore be limited to the details given above.

1. A method for data conversion for use by a computer station, referred to as “embedded platform”, comprising a portable object incorporating at least a processor, storage facilities and communication resources capable of exchanging information with a terminal in the form of one or more linear data sequences, wherein it includes a conversion step for a data set, in one direction or the other, between an arrangement comprising a linear data sequence on the one hand, and a structured arrangement describing or representing one or more software objects, structured or hierarchised according to the criteria of an object-oriented programming language on the other hand.

2. The method according to claim 1, wherein it includes the following steps: -conversion, or serialisation, of a first data set to be transmitted, comprising or representing one or more software objects, structured or hierarchised according to the criteria of an object-oriented programming language, from a structured arrangement describing or representing this object, to a linear data sequence representing said first data set; -transmission of said linear data sequence by communication resources from the embedded platform to at least one host, namely a terminal or computer station connected to the terminal, or from said host to embedded platform; -conversion after transmission, or deserialisation, of this linear data sequence to a data set arranged in one or more structured software objects reproducing or representing the first data set.

3. The method according to claim 1, wherein the host terminal sends information to the embedded platform, using a software agent, referred to as transmission function, said information being received in the embedded platform by a response function, capable of initiating a process for said data by at least one addressee software agent, stored in the embedded platform and forming part of at least one application, the method including the following steps: -reception by a communication agent, in place of addressee agent, of a data set received by the response function for said addressee software agent, said data set being arranged in a linear data sequence; -conversion of this data set into at least one software object, structured or hierarchised according to the criteria of an object-oriented programming language; -transmission of said structured software object to the addressee agent, and initiation of a process according to said object, by said addressee agent.

4. The method according to claim 1, wherein it includes the following steps: -reception by the response function from the transmission function of host, of at least one data item in the form of at least one transmission parameter, and transmission of this parameter to a communication agent stored or executed in embedded platform; -conversion, or concatenation, by the communication agent of at least one transmission parameter, transmitted by the response agent, into a data set arranged in a linear data sequence, and storage of these data in an input stream in the embedded platform; -conversion, or deserialisation, by a serialisation agent stored or executed in the embedded platform, of at least part of the data stored in said input stream to a data set comprising or representing at least one structured software object; -reception of said structured software object or its references by the addressee agent.

5. The method according to claim 1, wherein it includes the following steps: -transmission of a structured software object or its representation, from a software agent forming part of an application executed or stored in an embedded platform, to a serialisation agent executed or stored in said embedded platform; -conversion, or serialisation, by said serialisation agent of said structured software object to a data set arranged in a linear data sequence, and storage of these data in an output stream in the embedded platform; -conversion by a communication agent, stored or executed in the embedded platform, of at least part of the data stored in said output stream, to a response parameter set capable of being transmitted by the response function; -transmission of said response parameters from the embedded platform to the host terminal by the response function, at its own initiative or in response to the transmission function of host terminal.

6. The method according to claim 1, wherein the linear data sequence stored in the input stream or output stream represents one or more software objects structured or hierarchized using one or more data items, referred to as tags, with one or more given values each representing a given action to be executed on deserialisation of said linear data sequence.

7. The method according to claim 1, wherein at least one tag is defined as representing one of the following actions: -addition of a new element to the structure of the structured object represented by the linear data sequence; -reference to an element or object, referred to as source object, as the source of the value of all or part of an element making up the structured object; -indication that the following data item or items represent the content of an element making up the structured object; -indication of the absence of content for an element making up the structured object.

8. The method according to claim 1, wherein the serialisation agent serialises a structured object, referred to as source object, into a linear data set, following a procedure, referred to as serialisation procedure, processing at least one of the objects, referred to as elements, making up the structure or tree structure of said structured source object, by the following steps: -detection by the serialisation agent of the type, of an element, referred to as current object, making up the structure or tree structure of said structured object; -storage in the output stream of a data item representing a tag indicating the addition of a new element, followed by a data item representing the current object type (TYOBJ); -storage in the output stream, after the elements already present in the stream, by a type serialisation agent (TMO, IsM1, 15M2) associated with the current object type (TYOBJ): ‘either by means of a data item representing the value of all or part of the structured object,’ or by means of a data item representing a tag indicating a reference to an object as source of the value of all or part of the structured object, this tag being followed by a data item identifying said source object.

9. The method according to claim 1, wherein the serialization procedure converts a structured object to the output stream, storing, on each iteration, the type of each current object in a memory stack, referred to as type stack, the locations of which are read in reverse order to the order in which they were stored.

10. The method according to claim 1, wherein that the serialisation agent deserialises a linear data set into at least one structured result object, following a procedure, referred to as deserialisation procedure, processing each data item stored in the input stream, by the following steps: -read by the serialisation agent of at least one data item stored in the input stream after the data previously processed; -analysis of this data item and execution of an action corresponding to said data item.

11. The method according to claim 1, wherein the deserialisation procedure involves loading an element, referred to as current object, namely assignment of a direct or indirect value to all or part of said current object, said element making up all or part of the structure of structured result object, with termination of loading of the current object initiating: -read of a data item representing an object type stored in the next location of a memory structure, referred to as type stack, and erase of this data item from this location; -storage, as new current object type, of the type represented by the data item read from the type stack.

12. The method according to claim 1, wherein structured object created by the deserialisation procedure is considered to be complete and transmitted to the software agent or application, which is addressee for said object, when the type stack is empty.

13. The method according to claims 1, wherein the deserialisation action corresponding to a data item representing a tag, referred to as “NEW” tag, indicating a new element, involves the following steps: -read of at least one subsequent data item in the input stream; -storage of the object type, represented by said subsequent data item in a memory stack, referred to as type stack, following the types which may already have been stored.

14. The according to claim 1, wherein the type stack used by the deserialisation procedure comprises a LIFO type stack, namely where the locations are read in reverse order to that in which they were stored.

15. The method according to claim 1, wherein the deserialisation procedure includes a step for creation of an element making up the structure of the structured result software object, by allocation of a new memory space or reutilisation of a free allocation, said creation being executed by a type manager agent corresponding to the type of the element to be created.

16. The method according to claim 1, wherein the creation step for en element making up the structure of the structured result software object occurs between the read step for a data item indicating the creation of said element, and the first loading step for the same element.

17. The method according to claim 1, wherein the action corresponding to a data item, referred to as simple data item, namely not representing a tag, includes a storage step for the value of this data item in the memory space allocated to the current object.

18. The method according to claim 1, wherein, during the deserialisation procedure, an object index is assigned to at least one element making up the structure of the structured result object, said object index identifying said element in a unique manner, so that said element can be designated or referenced by other objects or elements.

19. The method according to claim 1, wherein the action corresponding to a data item representing a tag, referred to as “REF” tag, indicating a reference, includes the following steps: -read of at least one subsequent data item in the input stream; storage in the memory space allocated to the current object, following data already stored, of a data item designating an object as source of the value of all or part of the current object, said source object or element being identified by said subsequent data item.

20. The method according to claim 1, wherein the loading of the current object is considered to be terminated when the data stored in the allocated memory space correspond to a given length, said length being read from storage in card by a type manager agent or by a generic type manager agent in the embedded platform.

21. The method according to claim 1, wherein the transmission by the embedded platform to the host of a linear data sequence of a given length, is executed according to an iterative procedure, referred to as data read procedure, which includes the following recursive steps: -transmission of a communication command by the host, accompanied by at least one transmission parameter representing the length of the data already received; -reception by the embedded platform of the transmission parameter, and comparison with the linear data sequence to be transmitted; -response to the communication command by transmission of at least one return parameter, representing the data item or items following immediately after the data already received by the host; -reception by the host of the communication command return parameter, and storage of the data which it represents after the data already received.

22. The method according to claim 1, wherein the reception by the embedded platform from the host of a linear data sequence of a given length, is executed according to an iterative procedure, referred to as data write procedure, comprising the following recursive steps: -transmission by the host of a communication command accompanied by at least a first transmission parameter representing the data item or items following immediately after the part of the linear data sequence to be transmitted already sent, and where appropriate, a second transmission parameter representing the position, in the sequence to be transmitted, of the data represented by the first transmission parameter, or the length of the data already transmitted; -reception by the embedded platform of one or more communication command transmission parameters; storage in an input stream in the embedded platform of the data represented by the first transmission parameter, after the data already received.

23. The method according to claim 1, wherein the data write procedure also includes the following steps: -comparison by the embedded platform of the second transmission parameter, and comparison with the length of the data already received; -return by the embedded platform of at least one response parameter representing either the length of the data already received, or a data item representing the result of this comparison, or both.

24. The method according to claim 1, wherein at least two of the serialisation, deserialisation, data read or data write procedures are executed in parallel, or interleaved by repetition of a step including successive execution of at least one step of each of said procedures.

25. The method according to claim 1, wherein the input stream or output stream, or both, are stored in the form of circular memory structures, it being possible for said two streams to share the same circular structure.

26. The method according to claim 1, wherein the embedded platform has a programmable environment, capable of storing and executing at least one application created by a programmer, the communication function being compatible with the APDU format defined in standard ISO 7816.

27. The conversion procedure method according to claim 26, wherein deserialisation and treatment operations for an object received are initiated by reception of at least one APDU format command including at least one data item indicating reception of a structured object.

28. The method according to claim 1, wherein the embedded platform has a programmable environment compatible with the JavaCard® standard.

29. The method according to claim 1, wherein at least one of the applications executed on the host or embedded platform is programmed in Java® language.

30. The method according to claim 1, wherein the data read, data write, deserialisation or serialisation procedures are performed by implementation in at least one class stored in the host or embedded platform, said implementation including at least one of the following commands: -an object write command, transmitting a structured object to at least one agent of the embedded platform, by utilisation of the serialisation procedures for this object, followed by the data write and deserialisation procedures; -an object read command, reading a structured object from at least one agent of the embedded platform, by utilisation of the serialisation procedure method, followed by the data read and deserialisation procedures; -a deallocation command for a structured object stored in the embedded platform, by utilisation of the serialisation procedure, the latter also including a storage step for freeing or deallocation of the memory space allocated to each component of said object, after analysing the structure of this component; -a housekeeping or erase command for a memory space freed by a structured object, by utilisation of the deserialisation procedure to create an object with non-material content from a given linear data sequence; -a duplication command for a structured object, referred to as source object, by utilisation of the serialisation procedure without deallocation of said source object, to create a linear data sequence representing the same object, then by utilisation of the deserialisation procedure from said linear data sequence to create another structured object the content of which is identical to that of the source object.

31. The method according to claim 30, wherein the programming language of the embedded platform includes a first class (IOApplet), describing a ProcessAPDU abstract method, initiating a user-definable process in the application on reception of an APDU message; the program code executing deserialisation operations in the embedded platform being stored in said embedded platform, as implementation of said ProcessABDU abstract method, in a second class (ObjectIOApplet) inheriting the first class (IOApplet), said program code calling a processObject method, the latter being described as an abstract method in this same implementation class (ObjectIOApplet).

32. The method according to claim 1, wherein the programming language of the embedded platform includes a first class (IOApplet) describing a SendAPDU method transmitting an APDU format message to the host; the program code executing the serialisation operations in the embedded platform being stored, as an implementation of at least one SendObject method calling the SendAPDU method, in a second class (ObjectIOApplet) inheriting said first class (IOApplet).

33. The method according to claim 1, wherein it is used for communication between at least one software agent, referred to as card agent, stored or executed in the embedded platform, and at least one software agent, referred to as card engine proxy agent, stored or executed in at least one host belonging to a computer network communicating by asynchronous messages according to an AAA-MOM type software infrastructure, said card engine proxy agent serving as an intermediary for the card agent in its communications with other agents of said network, said agents operating in accordance with the specifications of said software infrastructure and belonging to at least one distributed application.

34. A Computer system comprising a computer station, referred to as embedded platform, comprising a portable object including at least a processor, storage facilities and communication resources capable of exchanging information with a terminal in the form of one or more linear data sequences, wherein the platform incorporates a serialisation agent, capable of executing a conversion step for a data set, in one direction or the other, between a linear data sequence arrangement on the one hand and a structured arrangement describing or representing one or more software objects structured or hierarchised in accordance with the criteria of an object-oriented programming language on the other hand.

35. The computer system according to claim 34, wherein the embedded platform includes a communication agent capable of: receiving, in place of the addressee agent, a data set received by the response function for an addressee software agent stored in the embedded platform, said data set being arranged in one or more linear data sequences; -converting said data set into at least one software object, structured or hierarchized according to the criteria of an object-oriented programming language; -transmitting said structured software object to the addressee agent, and initiating execution of a process, according to said object, by said addressee agent.

36. The computer system according to claim 34, wherein the linear data sequence representing a structured software object is stored in the embedded platform, in an input or output stream, the embedded platform incorporating a software agent, referred to as serialisation agent, capable of creating the structured object or objects represented by the input stream in the embedded platform, namely deserialising said structured objects, or writing data representing the structured object or objects to be transmitted in the output stream, namely serialising said structured objects.

37. The computer system according to claim 34, wherein the input stream or output stream is stored in the form of one or more circular memory structures.

38. The computer system according to claim 34, wherein the serialisation agent uses a memory stack, referred to as type stack, to store the type of at least one object making up all or part of the structure of a structured object to be serialised or deserialised, said type stack including memory locations none of which are accessible until the locations loaded more recently have been read and erased.

39. The computer system according to claim 34, wherein the data contained in the input or output stream represent one or more structured objects, using a code comprising a set of tags, each of said tags representing a given action to be executed on deserialisation of said linear data sequence.

40. The computer system according to claim 34, wherein at least one tag is defined as representing one of the following actions: -addition of a new element to the structure of the structured object represented by the linear data sequence; -reference to an element or object, referred to as source object, as the source of the value of all or part of an element making up the structured object; indication that the following data item or items represent the content of an element making up the structured object; -indication of the absence of content for an element making up the structured object.

41. The computer system according to claim 34, wherein the embedded platform includes a portable object operating in accordance with standard ISO 7816 and using APDU format commands.

42. The computer system according to claim 34, wherein at least one agent or application stored in the embedded platform is programmed in Java® language, the embedded platform having a computer environment in accordance with the JavaCard® standard.

43. The computer system according to claim 34, wherein it includes at least one software class in the host, embedded platform or both, implementing at least one of the following commands: an object write command, transmitting a structured object to at least one agent of the card, by serialisation of said structured object into a data stream in the host, followed by transmission of this data stream to the embedded platform, and deserialisation of said data stream into a structured object in the embedded platform; an object read command, reading a structured object from at least one agent of the card, by serialisation of said structured object into a data stream in the embedded platform, followed by reception of said data stream from the embedded platform, and deserialisation of said data stream into a structured object in the host; a deallocation command for a structured object stored in the embedded platform, by a serialisation of said object according to an option involving freeing or deallocation of the memory space allocated to each component of said object, after analysis of the structure of said component; a housekeeping or erase command for a memory space freed by a structured object in the embedded platform, by deserialisation of a given linear data sequence to create an object with non-material content; a command for duplication in the embedded platform of a structured object, referred to as source object, by serialisation into a linear data sequence representing the same object, without deallocation of said source object, followed by deserialisation from said linear data sequence into another structured object the content of which is identical to that of the source object.

44. The computer system according to claim 34, wherein the embedded platform communicates with at least one host belonging to a computer network communicating by asynchronous messages according to an AAA-MOM type software infrastructure, said host including a software agent, referred to as card engine proxy agent, capable of managing communications between said embedded platform and other agents of said network, said agents operating in accordance with the specifications of said software infrastructure and belonging to at least one distributed application.
